(19) United States
(12) Patent Application Publication
(10) Pub. No.: US 2008/0310144 A1
(43) Pub. Date: Dec. 18, 2008

(54) Pragmatic Portable LED light

(75) Inventor: Eric Hsin-Yi Wu, Garland, TX (US)

Correspondence Address: ERIC HSIN-YI WU, 2918 ANTARES CIR, GARLAND, TX, 75044, US

(73) Assignee: Eric Hsin-Yi Wu, Garland, TX (US)

(21) Appl. No.: 11/764,181

(22) Filed: Jun. 16, 2007

(51) Int. Cl. F21V 21/084

(52) U.S. Cl. 362/105

(57) ABSTRACT

The LED mount with a built-in circuit and a new design element allows the unit to receive interchangeable attachments (i.e. suction cup, headband, and clip) and significantly extends the use of LED lighting to more locations.

This new pragmatic portable LED light consists of one to cover, one bottom plate, one transparent plate, two waterproof barriers, one LED mount with one circuit and one reflector, and three interchangeable attachments; the three interchangeable attachments consist of one clip, one headband, and a piece of double-sided adhesive tape placed on the bottom plate. The LED mount is designed with a fixed receiving hole meant to secure the interchangeable attachments.

### BACKGROUND OF THE INVENTION

LED lighting is widely used today due to its unique characteristics as an energy efficient source of consistent illumination that is gentle to the human eye. Presently, LED lighting generally lacks the portability and convenience of other sources of lighting. The portability of an LED flashlight has its limitations as a portable unit; it must remain held by its user to keep its light targeted where needed; leaving the user with only a single hand to operate with.

### BRIEF SUMMARY OF THE INVENTION

The design of this new pragmatic portable LED light with interchangeable attachments significantly improves and increases the practicality and portability of current LED lighting. This newly designed pragmatic portable LED light serves many purposes; some examples of it's use include, but are not limited to, being used as a desk light, wall light, and flashlight. An LED light of this design can be used in many tight places and does not require being held by hand in such localities.

### BRIEF DESCRIPTION OF THE SEVERAL VIEWS OF THE DRAWINGS

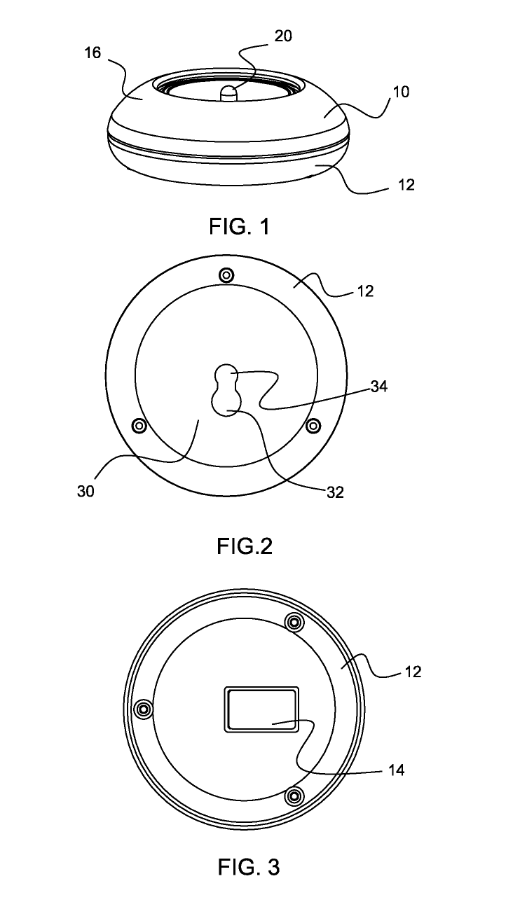

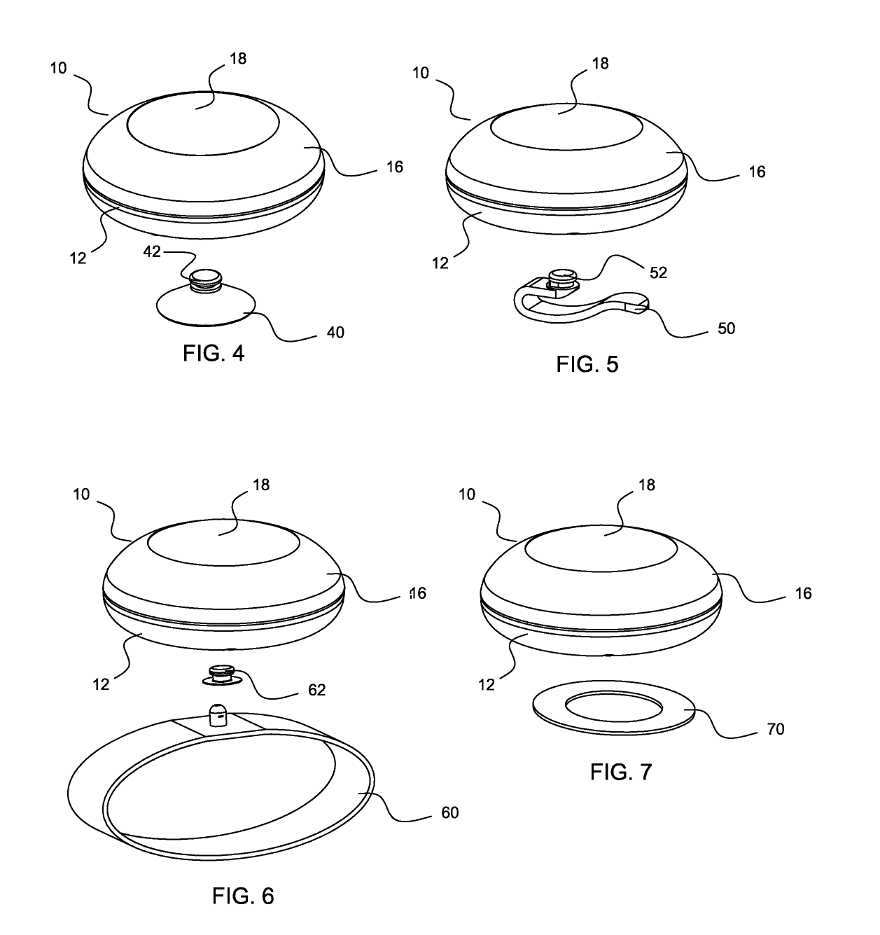

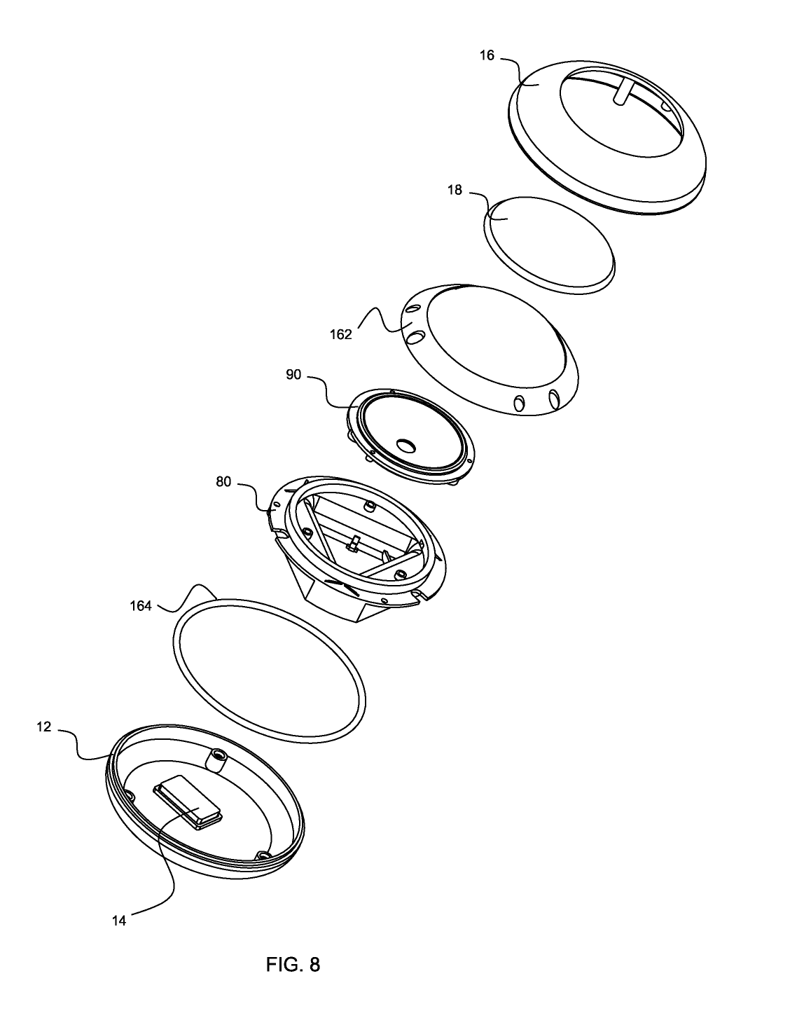

The design of this invention is demonstrated in multiple illustrations from different views and perspectives, a front view (FIG. 1), a top view (FIG. 2), a bottom view (FIG. 3), an illustration of the LED light with four different attachments connected (FIGS. 4, 5 6, and 7), and an exploded view of the LED light (FIG. 8).

### DETAILED DESCRIPTION OF THE INVENTION

Note FIG. 1, FIG. 2, FIG. 3 and FIG. 8: This new pragmatic portable LED light includes a base (10) consisting of one top cover (16), one bottom plate (12), and one transparent plate (18). One LED20 light and one LED20 circuit project through the transparent plate (18); the bottom plate (12) of the base unit (10) contains one receiving hole (30), which functions as an insertion location for the interchangeable attachments (40, 50, and 60).

To secure the receiving hole (30) to the interchangeable attachments, (40, 50, and 60) a pin built onto the receiving hole with two fixed diameters is used (32 and 34). Pegs located on the coordinating interchangeable attachments (40, 50, and 60) are inserted onto the pin on the receiving hole (30) and slid into place, locking the interchangeable attachments (40, 50, and 60) to the receiving hole (30) together.

The pragmatic portable LED light uses one partition board (14), located on the bottom plate (12) to prevent the intake of any liquid into the interior of the LED base (10) and also functions as a guard against any direct contact of the interior of the LED base and the interchangeable attachments (40, 50, and 60).

A single waterproof barrier (162) is located between the top cover (16) and the transparent plate (18) to prevent liquid from entering into the interior of the LED base (10). Another safeguard against liquid entering into the interior of the LED Base (10) is the use of a lower waterproof barrier (162), located between the LED base (10) and the bottom plate (12).

The pragmatic portable LED light can properly function at full capacity with no interchangeable attachments (40, 50, and 60) connected to the unit; it can stand-alone. Interchangeable attachments, the suction cup (40), the clip (50), and the headband (60) are accents to the unit and expand the functionality of the pragmatic portable LED light, assisting in providing illumination in almost every location. One piece of double-sided adhesive tape (70) is placed on the bottom plate (12) to reinforce the stability of the unit on a flat surface.

1. A multi-functional pragmatic portable LED light that resolves the limitations of functionality of other existing LED lights comprising of:
A stand-alone portable LED light adapting the use of double-sided adhesive tape
A stand-alone portable LED light adapting the use of a suction cup
A stand-alone portable LED light adapting the use of a clip
A stand-alone portable LED light adapting the use of a headband
With the use of the designated attachments made specifically for this pragmatic portable LED light, this pragmatic portable LED light can serve as a wall light, a desk light, a flashlight, a headlight, and a small area illumination unit.
